(19) United States
(12) Patent Application Publication
(10) Pub. No.: US 2005/0167641 A1
(43) Pub. Date: Aug. 4, 2005

(54) Ultrafine Modified Aluminum Hydroxide and Its Preparation

(76) Inventors: Jianfeng Chen, Beijing (CN); Fen Guo, Beijing (CN); Lei Liang, Beijing (CN); Zhigang Shen, Beijing (CN)

Correspondence Address: HASSE & NESBITT LLC, 7550 CENTRAL PARK BLVD., MASON, OH, 45040, US

(21) Appl. No.: 10/707,048

(22) Filed: Nov. 18, 2003

Related U.S. Application Data
(63) Continuation-in-part of application No. PCT/CN01/00810, filed on May 18, 2001.

(51) Int. Cl. C09K 21/00

(52) U.S. Cl. 252/604

(57) ABSTRACT

A method of preparing ultrafine modified aluminum hydroxide, having two steps: a carbon component decomposition under ultra gravity conditions in a rotating bed, and a modifying treatment. The carbon component decomposition is carried out in porous packing layer inside of a rotating bed, where the mass transfer for the reaction and micro-mixing process are extremely enhanced. The aluminum hydroxide solution (as a precipitate or a dry powder) obtained is further converted by the subsequent modified treatment process. This method can control the particle size of the modified aluminum hydroxide crystal grains, homogenize its distribution, and shorten the reaction time. Particularly, the modified treatment greatly improves its weight loss temperature and weight loss ratio. The use field of the resulting aluminum hydroxide as a flame retardant and other is expanded. The average size of modified aluminum hydroxide grain obtained is from 50 nm to several micrometers, and can be controlled. Its grain size can be homogeneously distributed and nano-graded. The mechanical properties of polymers containing the ultrafine modified aluminum hydroxide are improved. The process of the present invention can be conveniently used in industries and can improve productivity and the product grade.

### CROSS REFERENCE TO RELATED APPLICATIONS

This is a continuation-in-part of copending International Application PCT/CN01/00810, with an international filing date of May 18, 2001.

### BACKGROUND OF INVENTION

The present invention relates to a preparation method of ultrafine modified aluminum hydroxide (Al(OH)₃) under high gravity field in rotating beds and modifying condition, as well as modified product of Al(OH)₃ via this method. And also, the invention relates to the precursor of modified Al(OH)₃, that is to say, preparation method of ultrafine Al(OH)₃ and nanoscale Al(OH)₃ product thereof.

Aluminum hydroxide has been widely used in many fields such as chemical industry, ceramics, paint and paper making, and others. Because of its superfine particle size, ultrafine Al(OH)₃ has many significant merits that common Al(OH)₃ does not have. For example, used as fire retardant, it can greatly improve fire retardation. Meanwhile, it can be used as a precursor compound of ultrafine aluminum oxide, and used to prepare high activated catalyst. It can be applied to bio-ceramics and inorganic/organic nano-composite materials, and so on.

Traditional preparation method of Al(OH)₃ is to precipitate Al(OH)₃ from sodium aluminate (NaAlO₂) solution. The common methods of precipitation include an inoculating seed decomposition method where seed crystal is added to NaAlO₂ solution, and a carbon component decomposition method where CO is introduced into NaAlO₂ solution. These two kinds of methods are mostly mature in industry nowadays, while Al(OH)₃ product is always metallurgy grade having a particle size from tens to hundreds of micrometer. In order to acquire superfine particle, somebody attempted to expand and explore traditional method and achieved some new methods, such as Emile Trebillon (see U.S. Pat. No. 4,492,682), Bernard F. Armbrust (see U.S. Pat. No. 3,268,295). They use carbon component decomposition that introduces CO₂ into NaAlO₂ solution with severe stirring to generate gel. After washing and filtering, the gel is dispersed in other solution to get ultrafine Al(OH)₃ product after heating treatment. Nevertheless, the time of carbon component decomposition is too long. When solution volume is only 0.5 litre, carbon component decomposition process needs another 15 to about 30 min. to terminate the reaction. Moreover, efficiency is low, and the attained gel is not uniform.

Since all engineering plastics and specialty plastics are processed above 270° C., while Al(OH)₃ becomes dehydrated at about 205° C., Al(OH)₃ will generate bubbles in plastics. The surface of the polymer becomes rough, and the product characteristics are badly influenced. All of these limit its use range.

John M. Stinson and William E. Horn tested fire retardation of a type of modified Al(OH)₃, known as aluminum trihydroxides, or ATH, which was developed by Alcoa Technical Center (see Journal of Vinyl & Additive Technology, June 1995, Vol. 1, No. 2, pp. 94 to about 97). This kind of modified Al(OH)₃ has a relative good property, but the article does not disclose any detail of the preparation method about the modified Al(OH)₃.

So a need remains to develop a type of Al(OH)₃ product, which has good thermo-stability and a high initial weight loss temperature, and naturally, to develop a preparation method for such product.

### SUMMARY OF INVENTION

The present invention provides an ultrafine modified Al(OH)₃ whose X-ray diffraction (XRD) spectrum has diffraction peaks at the points where D value is 6.39, 6.16, 4.67 Å(Angstrom), and 2θ angle is 13.836, 14.347, and 19.006, respectively.

The present invention also provides a preparation method for an ultrafine modified Al(OH)₃, which comprises the steps of: (A) 1) introducing a CO₂-containing gas and a NaAlO₂ solution into a high gravity rotating bed apparatus, 2) reacting to form a reactant composition in the form of a gel or a liquid suspension, 3) filtering and washing to obtain a particulate Al(OH)₃ filter cake, and 4) optionally drying the filter cake to obtain a powdered product; wherein the gas/liquid volume flow rate is 0.5 to about 10, on the basis of standard pure CO₂, and the concentration of NaAlO₂ is 0.1 to about 10 mol/L; and (B) 5) mixing the particulate Al(OH)₃ obtained in Step A, with a modifying agent selected from the group consisting of an oxalate, an oxalic acid, or a mixture thereof, 6) reacting for a pre-determined period of time at a temperature equal to or higher than 100° C.; and 7) drying the reacted Al(OH)₃ to obtain an ultrafine modified Al(OH)₃ powder product.

The present invention also relates to an ultrafine modified Al(OH)₃ precursor and its preparation method. This method comprises the following steps: introducing a CO₂-containing gas and a NaAlO₂ solution into a high gravity rotating bed apparatus to react and generate a gel or suspending liquid; and filtering and washing the gel or suspending liquid to obtain Al(OH)₃ filter cake, which optionally is dried to obtain powder product; wherein the gas/liquid volume flow rate is 0.5 to about 10, on the basis of standard pure CO₂ and wherein the concentration of NaAlO₂ is 0.1 to about 10 mol/L, preferably about 1 to about 8 mol/L, and more preferably 1 to about 5 mol/L.

The modified Al(OH)₃ of the present invention has a high initial weight loss temperature and a high weight loss rate, which is very suitable for use as a fire retardant. The present invention can control the size of Al(OH)₃ particle within nanometer grade and make it uniformly distributed in the short reaction time of carbon component decomposition. The initial weight loss temperature can be raised to 330 to about 380° C., and preferably about 350 to about 380° C. At the same time, the rate of weight loss is up to about 50% before 500° C. So it can be applied to thermoplastic plastics whose processing temperature is over 270° C. as fire retardant.

### BRIEF DESCRIPTION OF DRAWINGS

FIGS. 1A and 1B show XRD patterns of a modified Al(OH)₃ of the invention.

FIG. 2 shows TA and TDA curves of a modified Al(OH)₃ of the invention.

FIG. 3 shows an FTIR spectra of a modified Al(OH)₃ of the invention.

FIG. 4 shows a TEM photograph of a modified Al(OH)₃ of the invention.

FIG. 5 shows a process flow chart to prepare a modified Al(OH)₃ of the invention.

FIG. 6 shows a TEM photograph of an ultrafine Al(OH)₃ gel, which is the precursor of the modified Al(OH)₃ of the invention.

FIG. 7 shows a schematic diagram of a high gravity rotating bed apparatus that can be used in the method of the invention.

### DETAILED DESCRIPTION

The present invention provides an ultrafine modified Al(OH)₃, whose XRD spectrum has diffraction peaks at the points that D values are 6.39, 6.16, 4.67 Å, and 2θ are 13.836, 14.347, and 19.006 respectively. The intensity of diffraction peaks where 2θ are 13.836 and 19.006 are 29.12% and 56.10% of the intensity of diffraction peak where 2θ is 14.347.

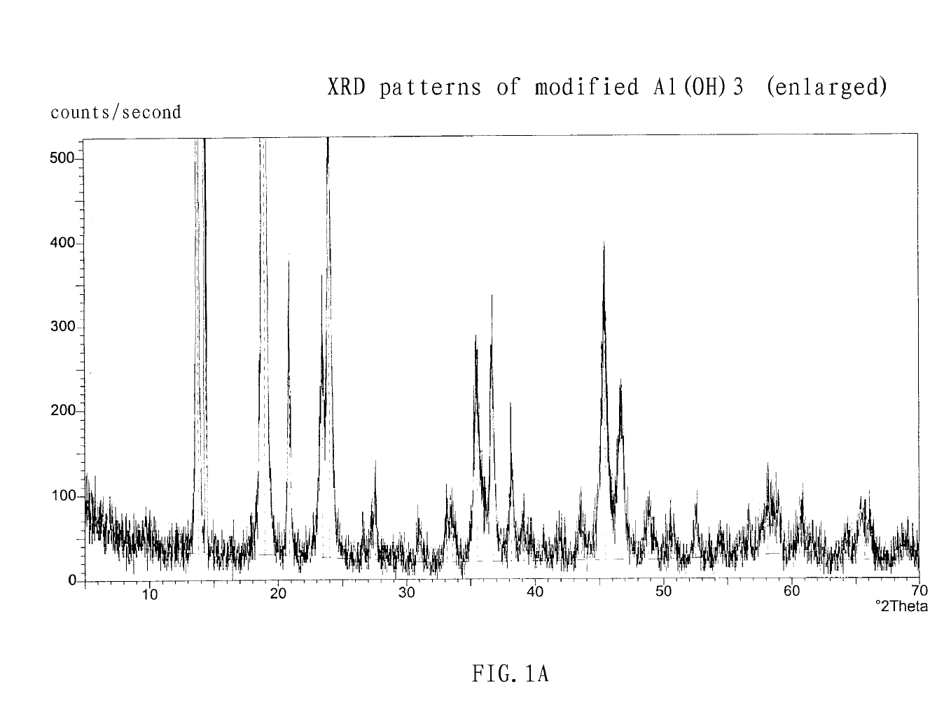

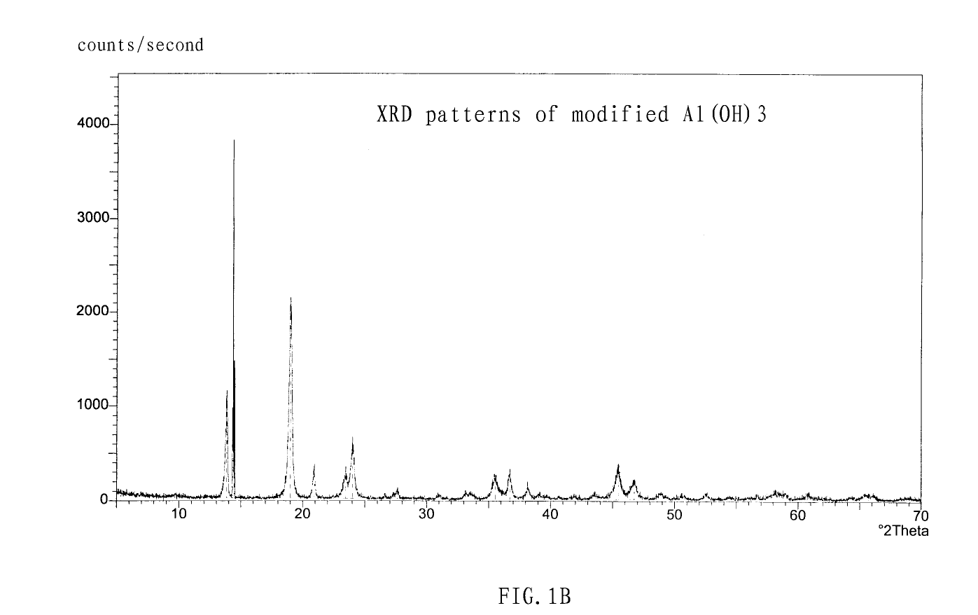

FIGS. 1A and 1B are XRD patterns of a modified Al(OH)₃ of the invention. The modified Al(OH)₃ of the present invention has intense diffraction peaks at several points where D values are 6.39, 6.16, 6.12, 4.67, 3.70 and 1.99 Å, and other peaks. The diffraction peaks where D values are 6.16, 2.36, and 1.86 Å are close to γ-AlOOH (21-1307), while the diffraction peaks where D values are 4.67, 4.24, 3.22, 2.44, 2.07, 1.80, and 1.74 Å, are close to Al(OH)₃ (Gibbsite) (33-18). The diffraction pattern of the product of the present invention does not include other diffraction peaks in the two phases mentioned above. And no known crystalline pattern has been found which coincidences to the diffraction peaks at which D values are 6.39, 3.70 and 6.12 Å, as in the diffraction pattern of the product of the invention.

According to the invention, ultrafine modified Al(OH)₃ has an initial weight loss temperature of greater than or equal to 330° C., preferably greater than or equal to 350° C., and more preferably greater than or equal to 370° C. For example, the initial weight loss temperature may be 330 to about 380° C., preferably is about 350 to about 380° C., and more preferably is 370 to about 380° C. The rate of weight loss is up to 50% at 500° C., while it is greater than or equal to 51% at 600° C. According to the experiments wherein a modified Al(OH)₃ is applied to polyvinyl chloride (PVC), ethylene-vinyl acetate copolymer (EVA), high density polyethylene (HDPE), polypropylene (PP), polyethylene (PE), acrylonitrile-butadiene-styrene terpolymer (ABS), polycarbonate (PC), for testing such physical properties as fire retarding and smoke eliminating, the results indicated that the ultrafine modified Al(OH)₃ of the invention can also be used in such materials as polycarbonate (PC), polyolefin (PO), polybutylene terephthalate (PBT), and others, to which conventional Al(OH)₃ can not be applied.

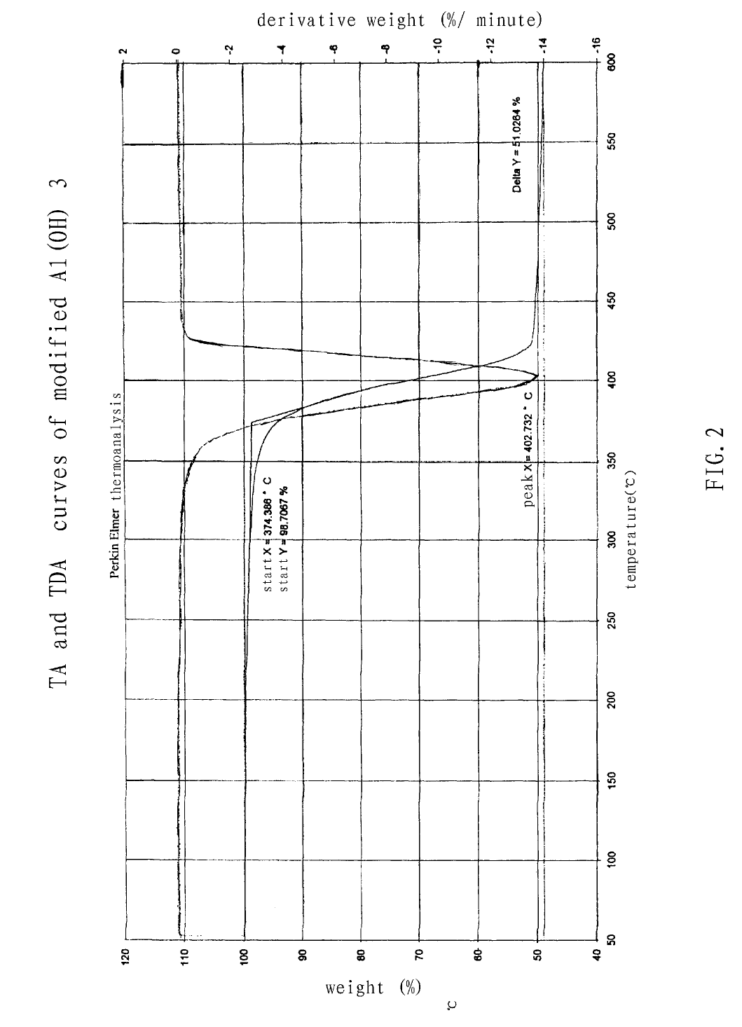

FIG. 2 shows Thermal Analysis (TA) and Thermdifferential Analysis (TDA) curves of a typical modified Al(OH)₃ of the invention. The experimental condition is to heat from a temperature of 50 to 600° C. at a rate of 10° C. per minute.

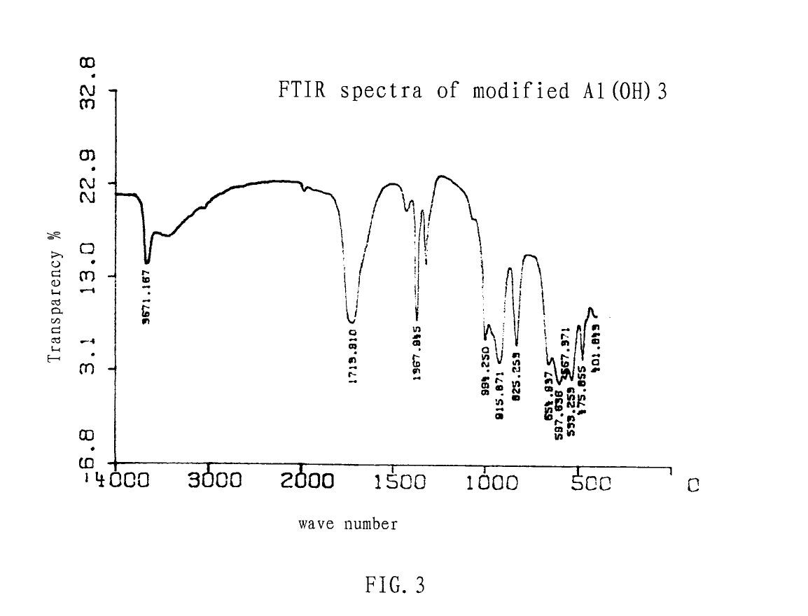

FIG. 3 is an FTIR spectra of the modified Al(OH)₃ of the invention. The modified Al(OH)₃ of the invention has adsorption peaks at the points that wave numbers are about 3671.167, 1713.910, and 1367.945.

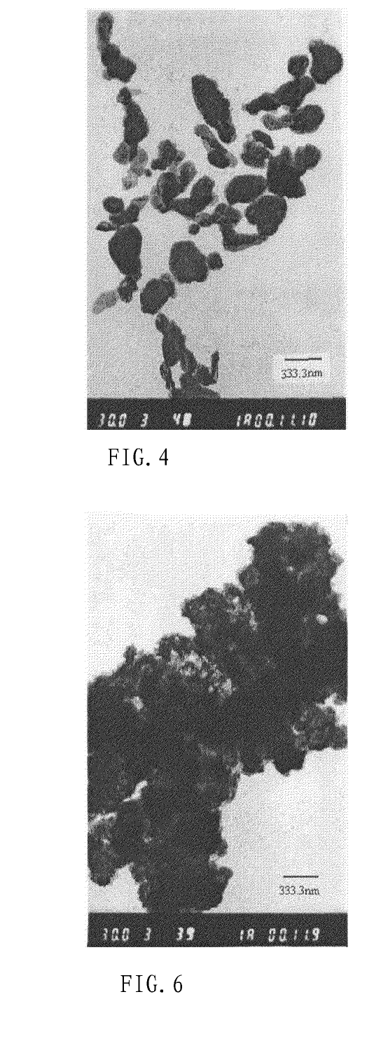

FIG. 4 is a TEM photograph of the modified Al(OH)₃ of the invention. The particle size of the ultrafine modified Al(OH)₃ is very small. The mean particle size is less than 300 nm, preferably less than 250 nm, and more preferably less than 200 nm. For example, the mean particle size is about 10 nm to 300 nm, preferably about 20 nm to about 250 nm and more preferably about 50 nm to 150 nm.

The density of modified Al(OH)₃ of the invention is 0.6 to about 1.1 g/cm³, preferably about 0.74 to about 1.04 g/cm³, while the loose density is 0.5 to about 0.9 g/cm³, preferably is about 0.54 to about 0.83 g/cm³.

The present invention also provides a method of preparin ultrafine modified Al(OH)₃, which comprises the steps of: (A) 1) introducing a CO₂-containing gas and a NaAlO₂ solution into a high gravity rotating bed apparatus, 2) reacting the CO₂ and the NaAlO₂ to form a reactant composition in the form of a gel or a liquid suspension, 3) filtering and washing to obtain a particulate Al(OH)₃ filter cake, and 4) optionally drying the filter cake to obtain powdered product; wherein the gas/liquid volume flow rate is 0.5 to about 10, on the basis of standard pure CO₂; and the concentration of NaAlO₂ is 0.1 to about 10 mol/L, preferably about 1 to about 8 mol/L, and more preferably 1 to about 5 mol/L; and (B) 5) mixing the particulate Al(OH)₃ obtained in Step A, with a modifying agent selected from the group consisting of an oxalate, an oxalic acid, or a mixture thereof, 6) reacting for a predetermined period of time at a temperature equal to or higher than 100° C., and 7) drying the reacted Al(OH)₃ to obtain the ultrafine modified Al(OH)₃ powder product.

In particular, the method of preparing ultrafine modified aluminum hydroxide according to the invention consists basically of two steps: A) a carbon component decomposition under conditions of a high gravity field in the high gravity rotating bed apparatus, and B) a modification treatment. The steps are described in detail as follows:

Step A: Carbon Component Decomposition:

A CO₂-containing gas and a NaAlO₂ solution are introduced into a high gravity rotating bed apparatus from a gas inlet and a liquid inlet, respectively. The carbon component decomposition reaction is carried out in the porous packing layers inside the rotating beds. A rotating speed of the rotor of a high gravity rotating bed apparatus is 100 to about 10,000 rpm. The gas/liquid volume rate is 0.5 to about 10, on the basis of standard pure CO₂. The concentration of NaAlO₂ is 0.1 to about 10 mol/L. The gel (or liquid suspension) leaves the high gravity rotating bed apparatus via a liquid outlet after the completion of the reaction.

Step B Modification Treatment:

The gel of Step A is filtered and washed to obtain a filter cake. The filter cake (or its dried powder after drying) is mixed with oxalic acid, oxalate, or a mixture thereof (as a solution and/or a solid), and reacted for 5 min. at a reaction temperature of not less than 100° C. After the modification reaction, the product is treated by such post-treatments as filtering and drying to obtain the modified nano-sized Al(OH)₃.

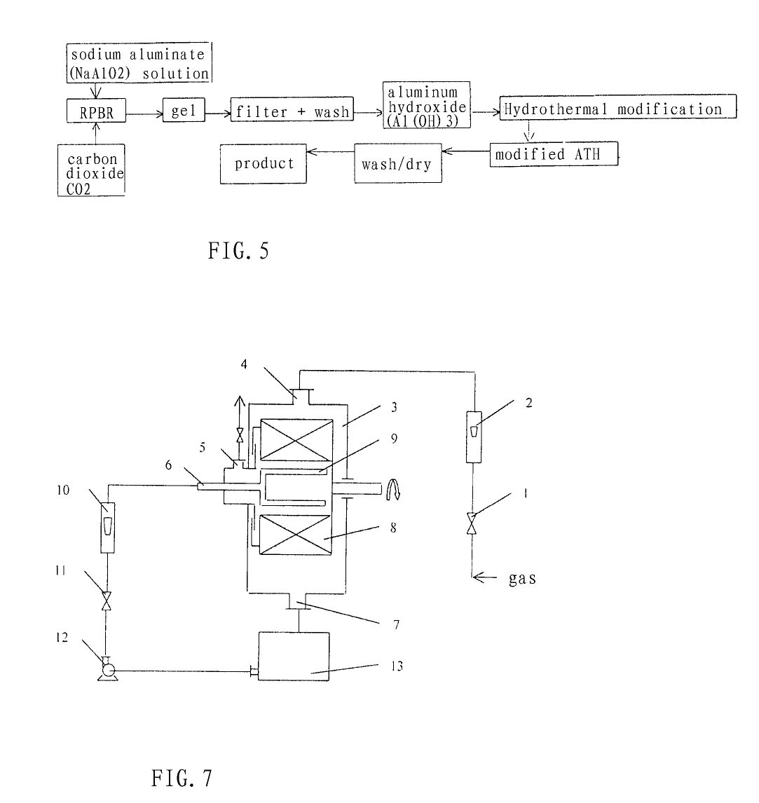

FIG. 5 depicts the process flow chart to prepare modified Al(OH) of the invention.

The essence of the carbon component decomposition reaction is: (1) First, because of the strong basicity of NaAlO₂ solution, the introduced CO₂ can neutralize hydroxyl (OH⁻) in the solution by the reaction (I):
CO₂+2OH⁻→CO₃²⁻+H₂O (I)

(2) Then, as a result of neutralizing CO₂, the NaAlO₂ solution loses its stability, and decomposes and precipitates out Al(OH)₃ by the reaction (11):
AlO₂⁻+2H₂O←→Al(OH)₃↓+OH⁻ (II)

The main purpose of carbon component decomposition process is to prepare a uniform gel (a precipitation of the Al(OH)₃) for the next modification step.

The carbon component decomposition process of step A of the present invention has no special requirement of reaction temperature, but it is preferable that the reaction of step A is carried out at the temperature of 15 to about 100° C., more preferably about 20 to about 80° C., and more preferably from 30 to about 70° C.

The rotating speed of the rotor of rotating beds can vary in a wide range, for instance 100 to about 10000 rpm, preferably about 150 to about 5000 rpm, and more preferably 200 to about 3000 rpm.

In Step A, the CO₂-containing gas mentioned above can be CO₂ of industrial purity or a mixture containing CO₂. The starting CO₂ content is preferably greater than or equal to 10%. The gas/liquid volume rate is 0.1 to about 5, on the basis of standard pure CO₂.

In Step A, the pH value of the gel or liquid suspension should be controlled at greater than or equal to 8, and preferably at greater than or equal to 11.5; for example, at pH=8 to about 13, or 8.5 to about 12.5.

The porous packing layers in Step A of the invention also have no special requirement. A porous plate, mesh, foam material and regular packing are all suitable for use in the present invention.

The reaction time in Step A can vary in a wide range, depending on the quantity of reactant and the volume of reactor, and other factors. The reaction time is usually 5 to about 60 min, preferably about 5 to about 30 min. Moreover, the activator and crystal form controlling agent can also be added in Step A, which cause full dispersion of particle, refine and narrow the distribution of particle size, and control the shape of modified Al(OH)₃ precursor. The mentioned activator can be, for example, fatty acid, and the crystal form control agent can be sulfate or phosphate. It is obvious to use any other common activator and crystal form controlling agent which are known in this art.

FIG. 7 shows the schematic diagram of a high gravity rotating bed apparatus, such as a Rotating Packed Beds Reactor (RPBR), according to the invention. The apparatus is described in detail in Chinese Patent No. ZL95105343.4, which is incorporated herein by reference.

The modifying agent used in Step B of the invention can bean oxalate, an oxalic acid, or a mixture thereof, which can be used in the form of a solution or a crystal. The examples of the oxalate include lithium, sodium and potassium oxalate.

The Al(OH)₃ used in Step B is a Al(OH)₃ gel or powder which is formed in the process of carbon component decomposition in Step A. The molar ratio of modifying agent in Step B to Al(OH)₃ filter cake or powder from Step A is 0.3 to about 2, preferably about 0.5 to about 1.5, and more preferably from 0.8 to 1.2. The mentioned modifying agent can be used in the form of a solid or a solution.

The temperature of modifying process in Step B is more than 100° C., for example 100 to about 205° C., and preferably from 140 to about 180° C.

The reaction time in Step B can alternate in a wide range, depending on the quantity of reactant and the volume of reactor. The reaction time in Step B is usually 5 min to about 5 hr, preferably about 10 min to about 2 hr, and more preferably 30 min to about 1.5 hr.

In the modification process of Step B of the invention, activator and crystal form controlling agent can also be added to cause full dispersion of particle, to refine and narrow the distribution of particle size, and to control the shape of modified Al(OH)₃ precursor. The examples of the activator include fatty acid or salt, ester aluminate, ester titanate, and others. The crystal form controlling agent is sulfate or phosphate. It is obvious to use any other common activator and crystal form controlling agent which are known in the art.

The present invention also provides a method of preparing ultrafine Al(OH)₃, which comprising the steps of: (A) 1) introducing a CO₂-containing gas and a NaAlO₂ solution into a high gravity rotating bed apparatus, 2) reacting the CO₂ and the NaAlO₂ to form a reactant composition in the form of a gel or a liquid suspension, 3) filtering and washing to obtain a particulate Al(OH)₃ filter cake, and 4) optionally drying the filter cake to obtain powdered product; wherein the gas/liquid volume flow rate is 0.5 to about 10, on the basis of standard pure CO₂; and the concentration of NaAlO₂ is 0.1 to about 10 mol/L, preferably about 1 to about 8 mol/L, and more preferably 1 to about 5 mol/L.

The ultrafine Al(OH)₃ according to the method can be used as a precursor of the modified Al(OH)₃ of the present invention. FIG. 6 shows a TEM photograph of an ultrafine Al(OH)₃ gel which is the precursor (product in Step A) of the modified Al(OH)₃ of the invention.

The present invention also provides a fire retardant product, which comprises the modified ultrafine Al(OH)₃ of the present invention. According to the experiments that modified Al(OH)₃ is applied to PVC, EVA, HDPE, PP, PE, ABS, PC, and others for testing the physical properties such as fire retarding and smoke eliminating, the results indicate that ultrafine modified Al(OH)₃ of the invention can also be used in such materials as PC, PO, PBT, and others, to which conventional Al(OH)₃ can not be applied, because of the high processing temperatures of these materials that exceed the thermal stability of conventional Al(OH)₃.

The followings are examples to illustrate the present invention. These examples by no means limit the scope of the invention.

### EXAMPLE 1

An aqueous solution of NaAlO₂ is prepared with a concentration of 2.18 mol/L. The solution was filtered to remove the impurities and placed in a circulating tank 13. The solution was pumped by pump 12 to liquid inlet 6 of rotat ing beds in a Rotating Packed Beds Reactor (RPBR) and entered into porous packing layer 8 at the temperature of 35° C. via distributor 9. CO₂ gas, after being decompressed from gas cylinder, was introduced to the rotating bed continuously from gas inlet 4. The gas/liquid volume flow rate was adjusted to 1.25. At this moment, a carbon component decomposition reaction take place between CO₂ and NaAlO₂ solution in the packing layer 8 of the beds to form a gel. The rotating speed of the rotor of the rotating bed was controlled to about 2100 rpm. Liquid which has not completely reacted flows to circulating tank 13 thru liquid outlet 7, and was recycled by circulating pump to react continuously with CO in the rotating. When the pH of the gel liquid became 12, the carbon component decomposition reaction was accomplished. The TEM photograph of the resulting gel is shown in FIG. 6. After filtering and washing, the gel was mixed with oxalic acid solution at a molar ratio of the gel: oxalic acid solution=1:0.87 to form a solution with Al(OH)₃ of about 46.3 g/L, so as to carry out modifying reaction. The reaction temperature was 150° C., while the reaction time was 4 to about 5 hr. The liquid product was filtered, washed and dried after the reaction finished, to obtain the modified Al(OH)₃. The TEM photograph of the modified Al(OH)₃ was shown in FIG. 4, and the TG/TGA of the modified Al(OH)₃ are shown in FIG. 3.

Chemical element analysis of the modified product was: Al 24.86%, O, 34.55%, C 11.86%, H 2.28%.

### EXAMPLE 2

The reaction was carried out in the same manner as Example 1, except that 14.5 g of Al(OH)₃ from carbon component decomposition reaction and 0.5 mol oxalic acid (350 ml) form a solution (550 ml) by adding water.

The density of the modified Al(OH)₃ product was 0.8 g/cm³, and specific surface area was 13 m²/g.

### EXAMPLE 3

The reaction was carried out in the same manner as Example 2, except that a NaAlO₂ solution with the concentration of 3.5 mol/L was used to prepare the Al(OH)₃ precursor, and 21.1 g of Al(OH)₃ precursor obtained from the carbon component decomposition reaction was mixed with 510 ml oxalic acid to form a solution (800 ml) by adding water. The time for modification is 90 to about 120 min.

### EXAMPLE 4

The reaction was carried out in the same manner as Example 2, except that 14.5 g Al(OH)₃ from the carbon component decomposition reaction was mixed with 81 gram oxalic acid (350 ml) to form a solution (800 ml) by adding water and that the time for modification was 45 to about 60 min.

### EXAMPLE 5

The reaction was carried out in the same manner as Example 2, except that 129 g filter cake of the Al(OH)₃ from the carbon component decomposition reaction was mixed with 1162 gram oxalic acid (350 ml) to form a solution (800 ml) by adding water and the time for modification was 20-30 min.

### EXAMPLE 6

The reaction was carried out in the same manner as Example 2, except that a NaAlO₂ solution (3.5 mol/L) was used to prepare Al(OH)₃ precursor, and 200 g Al(OH)₃ filter cake obtained from carbon component decomposition reaction was mixed with 226.5 g oxalic acid to form a solution (800 ml) by adding water and the time for modification was 15 to about 20 min.

### EXAMPLE 7

The reaction was carried out in the same manner as Example 6, except that the reaction of modification was carried out for 210 to about 270 min at 120° C.

### EXAMPLE 8

The reaction was carried out in the same manner as Example 6, except that the reaction of modification was carried out for 60-90 min at 135° C.

### EXAMPLE 9

The reaction was carried out in the same manner as Example 6, except that the reaction of modification was carried out for 5-10 min at 165° C.

TEM photographs and TA/DTA curves of the modified Al(OH)₃ and precursors obtained in Examples 2 to 9 are similar to those shown in FIGS. 1 to 5.

The present invention described by the examples is not limited to these examples. One of ordinary skill in the art can make modifications based on the present invention, which are within the scope of the claims attached hereto.

1. An ultrafine modified Al(OH)₃ having diffraction peaks by XRD spectrum at the locations that D values are 6.39, 6.16, 4.67 Å, and 2θ are 13.836, 14.347, and 19.006, respectively.

2. An ultrafine modified Al(OH)₃ of claim 1, wherein the intensities of diffraction peaks where 2θ are 13.836 and 19.006 are 29.12% and 56.10% of the diffraction peak where 2θ is 14.347.

3. The ultrafine modified Al(OH)₃ of claim 1, wherein the ultrafine modified Al(OH)₃ has an initial weight loss temperature of 330 to about 380° C., and the rate of weight loss is up to 51% at 600° C.

4. The ultrafine modified Al(OH)₃ of claim 3, wherein the initial weight loss temperature is about 350 to about 370° C.

5. The ultrafine modified Al(OH)₃ of claim 1, wherein the mean particle size is less than 300 nm.

6. The ultrafine modified Al(OH)₃ of claim 5 wherein the mean particle size is less than 250 nm.

7. The ultrafine modified Al(OH)₃ of claim 1 wherein the mean particle size is 300 to about 10 nm.

8. The ultrafine modified Al(OH)₂ of claim 1 wherein the density is 0.6 to about 1.1 g/cm³ and the loose density is 0.5 to about 0.9 g/cm³.

9. The ultrafine modified Al(OH)₃ of claim 1 wherein the density is about 0.74 to about 1.04 g/cm³, and the loose density is about 0.54 to about 0.83 g/cm³.

10. A method of preparing ultrafine modified Al(OH)₃, comprising the steps of:
(A) 1) introducing a CO₂-containing gas and a NaAlO₂ solution into a high gravity rotating bed apparatus, 2) reacting to form a reactant composition in the form of a gel or a liquid suspension, 3) filtering and washing to obtain a particulate Al(OH)₃ filter cake, and 4) optionally drying the filter cake to obtain a powdered product; wherein the gas/liquid volume flow rate is 0.5 to about 10, on the basis of standard pure CO₂, and the concentration of NaAlO₂ is 0.1 to about 10 mol/L; and (B) 5) mixing the particulate Al(OH)₃ obtained in Step A, with a modifying agent selected from the group consisting of an oxalate, an oxalic acid, or a mixture thereof, 6) reacting for a predetermined period of time at a temperature equal to or higher than 100° C.; and 7) drying the reacted Al(OH)₃ to obtain an ultrafine modified Al(OH)₃ powder product.

11. The method of preparing ultrafine modified Al(OH)₃ of claim 10 wherein the concentration of NaAlO₂ is about 1 to about 8 mol/L.

12. The method of preparing ultrafine modified Al(OH)₃ of claim 10 wherein the reaction temperature in Step B is less than 205° C.

13. The method of preparing ultrafine modified Al(OH)₃ of claim 12 wherein the reaction temperature in Step B is 140-180° C.

14. The method of preparing ultrafine modified Al(OH)₃ of claim 10 wherein the molar ratio of modifying agents in Step B to Al(OH)₃ filter cake or powder from Step A is 0.3 to about 2; and said modifying agents are in the form of a solid or a solution.

15. The method of preparing ultrafine modified Al(OH)₃ of claim 10 wherein the gas/liquid volume rate is 0.1 to about 5 in Step A, on the basis of standard pure CO₂, and the reaction temperature is 2θ to about 80° C.

16. The method of preparing ultrafine modified Al(OH)₃ of claim 10 wherein pH value of the reactant composition is controlled to greater than or equal to 8 in Step A.

17. The method of preparing ultrafine modified Al(OH)₃ of claim 16 wherein the pH is 8 to about 13.

18. The method of preparing ultrafine modified Al(OH)₃ of claim 10 wherein the oxalate is selected from a lithium, sodium and potassium oxalate.

19. The method of preparing ultrafine modified Al(OH)₃ of claim 10 wherein the activator and the crystal form controlling agent are added into Step A, into Step B, or both, and the activator is selected from the group consisting of fatty acid andits salt, ester aluminate, and ester titanate, and the crystal form controlling agent is selected from sulfate and phosphate.

20. A method of preparing ultrafine Al(OH)₃, comprising the steps of: introducing a CO₂-containing gas and a NaAlO₂ solution into a high gravity rotating bed apparatus, reacting and generating a reactant composition comprising a gel or a liquid suspension of Al(OH)₃; filtering and washing the reactant composition to obtain an Al(OH)₃ filter cake, and optionally drying the filter cake to obtain a powdered product; wherein the gas/liquid volume flow rate is 0.5 to about 10, on the basis of standard pure CO and wherein the concentration of NaAlO₂ is 0.1 to about 10 mol/L.

21. The method of preparing ultrafine modified Al(OH)₃ of claim 20 wherein the concentration of NaAlO₂ is about 1 to about 8 mol/L.

22. The method of preparing ultrafine modified Al(OH)₃ of claim 20 wherein the pH value of the reactant composition is greater than or equal to 8.

23. The method of preparing ultrafine modified Al(OH)₃ of claim 22 wherein the pH is 8 to about 13.

24. The ultrafine Al(OH)₃ product prepared by the method of claim 10.

25. The ultrafine Al(OH)₃ product of claim 24, wherein in the method the pH value of the reactant composition is greater than or equal to 8.

26. A fire retardant product comprisingan ultrafine modified Al(OH)₃ as a fire retardant, the ultrafine modified Al(OH)₃ having diffraction peaks by XRD spectrum at the locations that D values are 6.39, 6.16, 4.67 Å, and 2θ are 13.836, 14.347, and 19.006, respectively.

27. The fire retardant product of claim 26, wherein the intensities of diffraction peaks where 2θ are 13.836 and 19.006 are 29.12% and 56.10% of the diffraction peak where 2θ is 14.347.

28. The fire retardant product of claim 26, wherein the ultrafine modified Al(OH)₃ has an initial weight loss temperature of 330 to about 380° C., and the rate of weight loss is up to 51% at 600° C.

29. The fire retardant product of claim 26, wherein the mean particle size is less than 300 nm.

30. The fire retardant product of claim 26 wherein said the density is 0.6 to about 1.1 g/cm³.
